(19) United States
(12) Patent Application Publication
(10) Pub. No.: US 2025/0028964 A1
(43) Pub. Date: Jan. 23, 2025

(54) METHOD AND COMPUTER DEVICE FOR TRAINING A LARGE LANGUAGE MODEL

(71) Applicant: Garena Online Private Limited, Singapore (SG)

(72) Inventor: Qian LIU, Singapore (SG)

(21) Appl. No.: 18/778,445

(22) Filed: Jul. 19, 2024

(30) Foreign Application Priority Data
Jul. 21, 2023 (SG) 10202302062R
Jul. 18, 2024 (SG) 10202402138Y

(51) Int. Cl. G06N 3/082

(52) U.S. Cl. CPC G06N 3/082

(57) ABSTRACT

Various embodiments concern a method of training a large language model (LLM) for an unseen task T′ comprising: obtaining a plurality of pre-trained Low-Rank Adaptation (LoRA) modules, using a set of examples Q to obtain a set of weights for the plurality of pre-trained LoRA modules, using the set of weights on the plurality of pre-trained LoRA modules to obtain a fused LoRA module, and applying the fused LoRA module to the LLM to get an adapted LLM for the unseen task T′. Systems and machine-readable media are also provided.

### CROSS REFERENCE TO RELATED APPLICATIONS

This patent application claims the benefit of and priority to Singaporean Non-Provisional patent application Ser. No. 10202402138Y, filed with the Intellectual Property Office of Singapore on Jul. 18, 2024, entitled “METHOD AND COMPUTER DEVICE FOR TRAINING A LARGE LANGUAGE MODEL”, which claims priority to Singaporean Provisional Patent application Ser. No. 10202302062R, filed with the Intellectual Property Office of Singapore on Jul. 21, 2023, entitled “LORAHUB: FLEXIBLE CROSS-TASK GENERALIZATION VIA DYNAMIC LORA MODULE COMPOSITION”, the contents of which are incorporated by reference in their entirety and for all purposes.

### TECHNICAL FIELD

Various aspects of this disclosure relate to methods and computing devices for training a large language model.

### BACKGROUND

Recent advancements in natural language processing (NLP) have been largely driven by large-scale pretrained language models (LLMs) such as OpenAI GPTs, Flan-T5, and LLaMA, etc., which achieve state-of-the-art performance on a wide array of NLP tasks. However, the massive parameter size of these LLMs poses challenges in terms of computational efficiency and memory consumption during fine-tuning.

Accordingly, efficient approaches for natural language processing are desirable.

### SUMMARY

Various embodiments concern a method of training a large language model (LLM) for an unseen task T′ comprising: obtaining a plurality of pre-trained Low-Rank Adaptation (LoRA) modules; using a set of examples Q to obtain a set of weights for the plurality of pre-trained LoRA modules; using the set of weights on the plurality of pre-trained LoRA modules to obtain a fused LoRA module; applying the fused LoRA module to the LLM to get an adapted LLM for the unseen task T′.

According to one embodiment, the adapted LLM is obtained by freezing original weights of the LLM and introducing low-rank matrices from the fused LoRA module that modifies a subset of the original weights of the LLM.

According to one embodiment, the plurality of pre-trained LoRA modules are trained using a plurality of upstream tasks T. The plurality of upstream tasks T are N different types of upstream tasks for cross-task generalization.

According to one embodiment, the plurality of pre-trained LoRA modules used to obtain the fused LoRA module have a same rank.

According to one embodiment, the set of weights is obtained through a gradient free algorithm. The set of weights are obtained through the gradient free algorithm minimizes cross entropy loss on the set of examples Q.

According to one embodiment, the set of examples Q is related to the unseen task T′. The number of examples Q may be a relatively small number, for example, 5 examples.

Various embodiments concern a computer device for training a large language model (LLM) for an unseen task T′ comprising: a processor, a memory, the memory storing at least one program code, the at least one program code loaded and executed by the processor to: obtain a plurality of pre-trained Low-Rank Adaptation (LoRA) modules; use a set of examples Q to obtain a set of weights for the plurality of pre-trained LoRA modules; use the set of weights on the plurality of pre-trained LoRA modules to obtain a fused LoRA module; apply the fused LoRA module to the LLM to get an adapted LLM for the unseen task T′.

According to one embodiment, the adapted LLM is obtained by freezing original weights of the LLM and introducing low-rank matrices from the fused LoRA module that modifies a subset of the original weights of the LLM.

According to one embodiment, the plurality of pre-trained LoRA modules are trained using a plurality of upstream tasks T. The plurality of upstream tasks T are N different types of upstream tasks for cross-task generalization.

According to one embodiment, the plurality of pre-trained LoRA modules used to obtain the fused LoRA module have a same rank.

According to one embodiment, the set of weights is obtained through a gradient free algorithm. The set of weights are obtained through the gradient free algorithm minimizes cross entropy loss on the set of examples Q.

According to one embodiment, the set of examples Q is related to the unseen task T′. The number of examples Q may be a relatively small number, for example, 5 examples.

According to one embodiment, a computer readable storage medium, characterized in that the storage medium stores at least one program code for execution by a processor to implement the training method described above.

According to one embodiment, a computer program product, the computer program product comprising computer instructions stored in a computer readable storage medium; a processor of a computer device reads the computer instructions from the computer readable storage medium, the processor executing the computer instructions, causing the computer device to implement the training method described above.

It should be noted that embodiments described in context of the method of training a large language model are analogously valid for the computer device and vice versa.

### BRIEF DESCRIPTION OF THE DRAWINGS

The invention will be better understood with reference to the detailed description when considered in conjunction with the non-limiting examples and the accompanying drawings, in which:

FIGS. 1A-D show exemplary illustrations of various NLPs and their results.

FIG. 2 shows an exemplary method of training a large language model according to an embodiment.

FIG. 3 shows an exemplary illustration of LoRA modules phases: compose and adapt, according to an embodiment.

FIGS. 4A-4C show exemplary results of various NLPs according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the computer device or methods are analogously valid for the other computer device or methods. Similarly, embodiments described in the context of a computer device are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

Recent progress in natural language processing (NLP) has been driven by large pretrained language models (LLMs), and the Low-Rank Adaptation (LoRA) technique has been proposed to efficiently fine-tune LLMs.

Previous work on LoRA mainly focused on its efficiency side, but less on the composability of LoRA modules.

According to various embodiments, a plurality of LoRA modules maybe grouped together to form a LoRAHub, which is a strategic framework for composing a plurality of LoRA modules trained on different seen tasks to attain adaptable performance on unseen tasks. With a few examples (e.g., 5 examples) from an unseen task, the LoRAHub may enable automatic composition of different LoRA modules without any human expertise. Experimental results on the Big-Bench Hard (BBH) benchmark show that LoRAHub can attain performance approaching that of in-context learning in few-shot scenarios, without needing to provide examples alongside each input during inference.

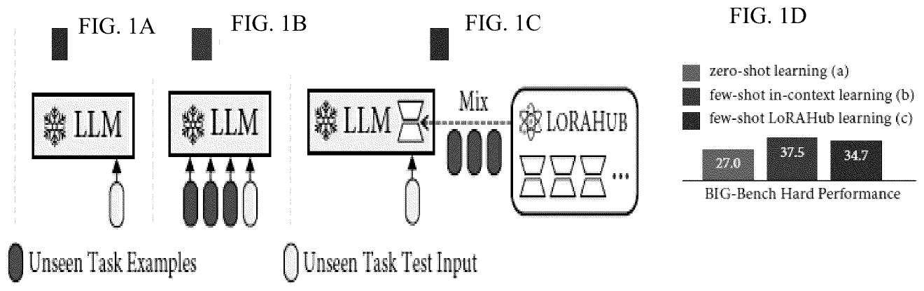

The Beyond the Imitation Game Benchmark (BIG-bench) is a collaborative benchmark intended to probe large language models and extrapolate their future capabilities. Big-Bench Hard (BBH) is a subset of challenging tasks from the BIG-bench. FIGS. 1A-D show exemplary illustrations of various NLPs and their results.

FIG. 1A shows an exemplary illustration of zero-shot learning LLM. Zero-shot learning (ZSL) is a machine learning scenario in which the LLM is trained to recognize and categorize objects or concepts without having seen any examples of those categories or concepts beforehand.

FIG. 1B shows an exemplary illustration of few-shot in-context learning LLM. Few-shot learning is a machine learning approach that uses parameter adaptation to learn the best model parameters for the task with a limited number of supervised examples.

FIG. 1C shows an exemplary illustration of few-shot LoRAHub learning according to an embodiment.

Low-Rank Adaptation (LoRA) is a parameter-efficient fine-tuning method to expedite the training of LLMs while substantially reducing memory requirements and computation. By freezing the parameters of the base model (e.g., LLM) and training a pluginable LoRA module, LoRA training tends to yield strong performance on downstream tasks.

FIG. 1D shows the results of the various NLPs of FIGS. 1A-1C.

The method disclosed herein (FIG. 1C) achieves similar inference throughput as zero-shot learning (FIG. 1A), yet approaches the performance of in-context learning (FIG. 1B) on the BIG-Bench Hard (BBH) benchmark.

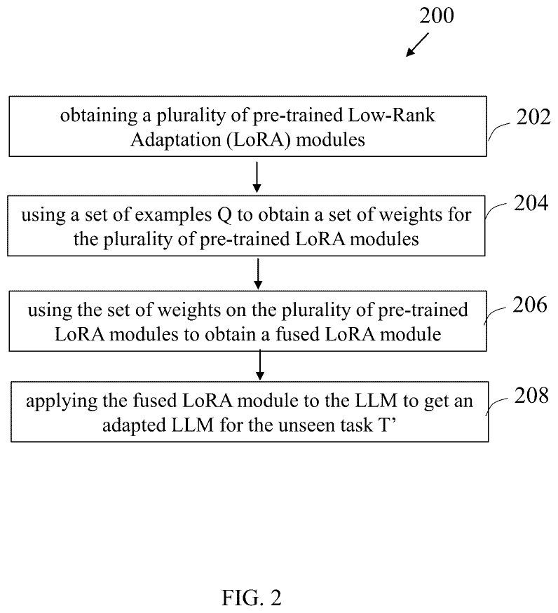

FIG. 2 shows an exemplary method of training a large language model according to an embodiment.

As shown in FIG. 2, there may be a method 200 of training a large language model. In the method 200, a first step 202 may include obtaining a plurality of pre-trained Low-Rank Adaptation (LoRA) modules. A second step 204 may include using a set of examples Q to obtain a set of weights for the plurality of pre-trained LoRA modules. A third step 206 may include using the set of weights on the plurality of pre-trained LoRA modules to obtain a fused LoRA module. A fourth step 208 may include applying the fused LoRA module to the LLM to get an adapted LLM for the unseen task T′.

It will be understood that the above operations described above relating to FIG. 2 are not limited to this particular order. Any suitable, modified order of operations may be used.

In various embodiments, a computer device for training a large language model (LLM) for an unseen task T′ may include a processor for performing computing tasks such as NLP and LLM training. The computer device may also include a memory. The memory may store at least one program code, the at least one program code loaded and executed by the processor to train a large language model.

In an embodiment, the processor may obtain a plurality of pre-trained Low-Rank Adaptation (LoRA) modules.

In an embodiment, the processor may use a set of examples Q to obtain a set of weights for the plurality of pre-trained LoRA modules.

In an embodiment, the processor may use the set of weights on the plurality of pre-trained LoRA modules to obtain a fused LoRA module.

In an embodiment, the processor may apply the fused LoRA module to the LLM to get an adapted LLM for the unseen task T′.

According to one embodiment, the adapted LLM is obtained by freezing original weights of the LLM and introducing low-rank matrices from the fused LoRA module that modifies a subset of the original weights of the LLM.

According to one embodiment, the plurality of pre-trained LoRA modules are trained using a plurality of upstream tasks T. The plurality of upstream tasks T are N different types of upstream tasks for cross-task generalization.

According to one embodiment, the plurality of pre-trained LoRA modules used to obtain the fused LoRA module have a same rank.

According to one embodiment, the set of weights is obtained through a gradient free algorithm. The set of weights are obtained through the gradient free algorithm minimizes cross entropy loss on the set of examples Q.

According to one embodiment, the set of examples Q is related to the unseen task T′. The number of examples Q may be a relatively small number, for example, 5 examples.

According to one embodiment, a computer readable storage medium, characterized in that the storage medium stores at least one program code for execution by a processor to implement the training method described above.

According to one embodiment, a computer program product, the computer program product comprising computer instructions stored in a computer readable storage medium; a processor of a computer device reads the computer instructions from the computer readable storage medium, the processor executing the computer instructions, causing the computer device to implement the training method described above.

In an embodiment, the plurality of LoRA modules may be used for task generalization. The technique moves beyond single-task training to strategically compose LoRA modules for adaptable performance on unseen tasks. This approach enables automated LoRA module composition without reliance on manual design or human expertise. With just a few examples from unseen tasks (e.g. 5 examples), this method may automatically compose any compatible LoRA modules without human intervention.

In other words, prior assumptions are not made on which LoRA modules trained on which tasks can be composed, granting flexibility to combine any modules as long as the modules adhere to the specification (e.g., using the same LLM).

In an embodiment, since this approach utilizes several LoRA modules, it may be referred to as LoRAHub and the method of using the LoRAHub may be referred to as LoRAHub learning.

To verify the effectiveness of the LoRAHub, experiments have been conducted on the widely used BBH benchmark with FLAN-T5 large as the LLM. Experimental results demonstrate the efficacy of composing LoRA modules for unseen tasks through few-shot LoRAHub learning. For example, this method achieved an average score of 34.7 over five runs, approaching the performance of few-shot in-context learning (37.5). However, the inference cost of this method is much lower than in-context learning, since there is no need to provide examples as input to the LLM.

Furthermore, this learning procedure is computationally efficient as it uses a gradient-free approach to tune the compositional coefficients of LoRA modules, needing just a few inference steps on the unseen task. In the experiments, few-shot LoRAHub learning on each BBH task took less than 1 minute with a single A100 card.

Lastly, the development of a LoRA Module allows users to share the LoRA modules they have trained so that others can leverage them for new tasks. This can grow into a repository of reusable LoRA modules that cover a diverse range of capabilities. It precipitates collaborative AI development, allowing the community to collectively expand the capabilities of LLMs through dynamic LoRA module composition. Sharing and reusing modules can maximize the value across tasks, users and computation resources.

In an embodiment, the large language model Me may be based on Transformer architecture and may be pre-trained on a large-scale natural language corpus.

The model architecture can be either encoder-decoder or decoder-only. Also, Me could also have been fine-tuned with a large set of instruction following datasets such as FLAN Collection and PromptSource.

In an embodiment, any suitable large language model (LLM) may be used.

In an embodiment, the LoRA module may utilize Cross-Task Generalization. Assuming there are N different upstream tasks, dubbed as T={T₁, . . . , T_{N}}. In real-world scenarios, it is very common that users want a specialized model to perform their own tasks that are never seen before by the LLM. For a target task T′/∈T, users may only provide a small set of examples Q. The goal is to adapt the LLM M_{θ} to generalize to task T′ using only Q to achieve cross-task generalization.

Previously, a straightforward approach is to directly fine-tune the weights of M_{θ} on Q to get an updated model M_{ϕ} that performs better on T′ (as shown in FIG. 1B). However, this can be inefficient, slow and unstable when Q is small.

In an embodiment, LoRA Tuning Low-rank adaptation (LoRA) is a parameter-efficient fine-tuning method that can adapt LLM using only a small external module, rather than fine-tuning the weights of the entire LLM. LoRA works by freezing the weights of the LLM and inserting trainable low-rank decomposition matrices into each layer as an adapter module. This module has far fewer trainable parameters than the full LLM, enabling rapid and stable adaptation using limited examples. Therefore, LoRA provides an efficient approach to rapidly personalize LLMs for new tasks using limited training data.

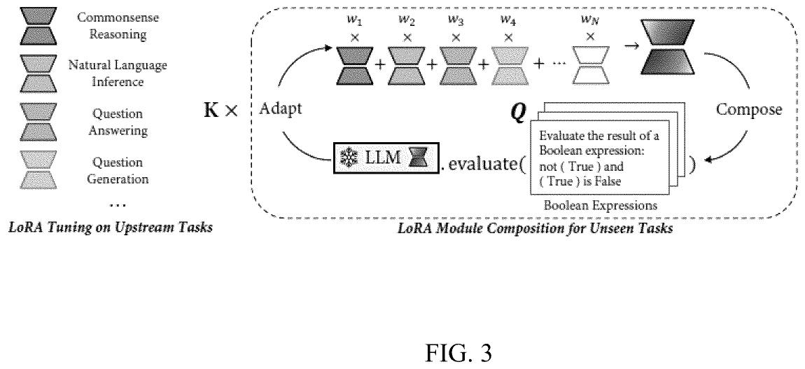

FIG. 3 shows an exemplary illustration of LoRA modules phases: compose and adapt, according to an embodiment.

The LoRAHub method comprises of two phases: Compose and Adapt. In the Compose phase, the pretrained LoRA modules are fused into a single module using a set of weight ω. In the Adapt phase, the fused LoRA module is evaluated on the few-shot examples from the unseen task. Then a gradient-free algorithm is employed to adapt the weights into a new set of weights. After performing N iterations, a well-adapted LoRA module is obtained.

As shown in FIG. 2, given N different upstream tasks, separately train N specified upstream LoRA modules, named mi for task Tᵢ ∈T. Then, given a unseen new task T′/∈T, there is small set of examples Q. The set of examples Q is used to guide the composition of these LoRA modules.

In the compose stage, a set of weights {w1, w2, . . . , wN} is obtained via gradient-free optimization algorithms. Then, the weights and upstream LoRAs is used to obtain a fused LoRA module \hat{m}⁻ via \hat{m}⁻=w₁×m₁+w₂×m₂+ . . . +w_{N}×m_{N}, such that \hat{m}⁻ can achieve better performance on the few-shot examples Q. Finally, the fused LoRA module is applied on the LLM M_{θ} to get the final adapted LM M_{ϕ}=LoRA (M_{θ}, \hat{m}⁻) as a well-adapted model for the unseen task T′.

LoRA decomposes attention weight update into low-rank matrices to reduce the number of trainable parameters. In detail, to impose constraints on the update of a pre-trained weight matrix W0∈R^{d×k}, LoRA employ a low-rank decomposition representation W₀+δW=W₀+AB, where A∈R^{d×r}, B∈⁻R^{r×k}, and the rank r is set much smaller than d and k for a reduction in the number of trainable parameters. In an embodiment, m=AB represents a LoRA module.

An element-wise composition methodology is employed to combine LoRA modules. This technique entails adding the parameters at corresponding positions to achieve compose. This requires the LoRAs that need to be fused to have the same rank r in order to have matching structures:

$$\hat{m} = ( {w}_{1} {A}_{1} + {w}_{2} {A}_{2} + … + {w}_{N} {A}_{N} ) ( {w}_{1} {B}_{1} + {w}_{2} {B}_{2} + … + {w}_{N} {B}_{N} ) .$$

Optimizing the weights for LoRA modules, like hyperparameter search, presents challenges and necessitates additional memory space for gradient backpropagation.

In an embodiment, a gradient-free alogorithm to search suitable weights. Throughout the optimization process, the procedure is guided using the cross entropy loss. The aim is to discover a set of weights that minimizes the loss on the validation set Q.

In an embodiment, an combinatorial optimization method which incorporates a comprehensive set of algorithm and selects appropriate optimization algorithms based on different scenarios may be used. Subsequent experimental scenarios primarily utilize the Covariance Matrix Adaptative evolution strategies (CMA-ES) CMA-ES is a stochastic optimization algorithm employed for solving continuous optimization problems. This algorithm is population-based and does not rely on derivative information, making it suitable for a wide range of optimization tasks. CMA-ES operates by utilizing a covariance matrix to adapt the search distribution, iteratively updating the mean and covariance of the distribution to optimize the objective function.

In an embodiment, LoRA reduces the number of trainable parameters by learning pairs of rank-decompostion matrices while freezing the original weights. This vastly reduces the storage requirement for large language models adapted to specific tasks and enables efficient task-switching during deployment all without introducing inference latency. LoRA also outperforms several other adaptation methods including adapter, prefix-tuning, and fine-tuning.

In the experiment, FLAN-T5 which is a series of language models with similar structures but different sizes is chosen as the base language models. FLAN-T5 demonstrates outstanding zero-shot and few-shot capabilities within the corresponding sizes of the models. The experiments mainly focus on FLAN-T5 large (780M parameters).

In the experiment, there is a collection of trained LoRAs. FLAN provides nearly 200 different tasks and their instructions. Based on this, approximately 200 LoRA modules were trained as the potential candidates. 20 LoRA modules were randomly selected as candidates during the experimental process each time.

The experiment was conducted using the widely used BBH benchmark. BBH includes of a set of multiple-choice questions, sourced from a group of various. 27 tasks were used as a challenging benchmark for language models. In all tasks, exact match (EM) was used as the evaluation metrics.

In the experiment, PEFT was used to implement the LoRA and the rank r=16 was the default LoRA tuning hyperparameter. The gradient-free method is implemented by the open-source gradient-free optimization library nevergrad In this implementation, a constraint was imposed that the absolute value of LoRA weights should not exceed 1.5, with an initial point of zero weights for all LoRA modules. In the default settings, the maximum step size was set to 40, meaning that a maximum of 40 attempts can be made to calculate the loss on the samples and only 5 examples are used during the optimization. As for hyperparameters used when training candidate LoRA modules, the batch size, learning rate, and number of training epochs were fixed at 64, 1e⁻⁴, and 10 respectively for all candidate LoRA modules.

TABLE 1

| Task | Zero | ICL | LoRAHub_{avg} | LoRAHub_{best} |
|---|---|---|---|---|
| Boolean Expressions | 54.0 | 58.7 | 56.0 | 59.3 |
| Casual Judgement | 57.5 | 56.3 | 58.9 | 63.2 |
| Date Understanding | 15.3 | 22.7 | 29.6 | 38.0 |
| Disambiguation | 0.00 | 69.3 | 46.0 | 69.3 |
| Dyck Languages | 1.3 | 7.3 | 0.3 | 1.3 |
| Formal Fallacies | 51.3 | 58.0 | 52.1 | 55.3 |
| Geometric Shapes | 6.7 | 18.7 | 7.5 | 9.3 |
| Hyperbaton | 6.7 | 74.0 | 57.5 | 61.3 |
| Logical Deduction^{§} | 21.3 | 40.0 | 38.1 | 40.7 |
| (five objects) | | | | |
| Logical Deduction^{§} | 12.7 | 42.0 | 40.3 | 44.7 |
| (seven objects) | | | | |
| Logical Deduction^{§} | 0.0 | 51.3 | 49.7 | 51.3 |
| (three objects) | | | | |
| Movie Recommendation | 62.7 | 52.7 | 61.1 | 64.0 |
| Multistep Arithmetic | 0.7 | 0.7 | 0.7 | 0.7 |
| Navigate | 47.3 | 44.0 | 46.1 | 49.3 |
| Object Counting | 34.7 | 32.0 | 35.0 | 38.0 |
| Penguins in a Table | 43.5 | 39.1 | 43.9 | 45.7 |
| Reasoning about Colored Objects | 32.0 | 38.7 | 36.5 | 40.7 |
| Ruin Names | 23.3 | 18.7 | 21.0 | 23.3 |
| Salient Translation Error Detection | 37.3 | 46.0 | 37.3 | 37.3 |
| Snarks | 50.0 | 55.1 | 51.8 | 59.0 |
| Sports Understanding | 56.0 | 56.0 | 48.3 | 53.3 |
| Temporal Sequences | 16.7 | 26.7 | 18.7 | 21.3 |
| Tracking Shuffled Objects^{§} | 12.0 | 12.0 | 12.0 | 12.0 |
| (five objects) | | | | |
| Tracking Shuffled Objects^{§} | 6.7 | 6.7 | 7.1 | 8.7 |
| (seven objects) | | | | |
| Tracking Shuffled Objects^{§} | 24.7 | 30.7 | 29.0 | 30.7 |
| (three objects) | | | | |
| Web of Lies | 54.0 | 54.0 | 53.0 | 54.7 |
| Word Sorting | 1.3 | 0.7 | 1.1 | 1.3 |
| Average Performance per Task | 27.0 | 37.5 | 34.7 | 38.3 |
| Average Consumed Tokens per Example | 111.6 | 597.8 | 111.6 | 111.6 |

Table 1 shows the performance comparison between zero-shot learning (Zero), few-shot in-context learning (ICL) and the proposed few-shot LoRAHub learning (LoRAHub). The average performance of LoRAHub is calculated across 5 runs with different random seeds, and the best performance is reported as the maximum value over these runs for reference.

As shown in Table 1, the proposed method is comparable to in-context learning (ICL) in the overall 5-shot scenario in average. It is worth noting that the method have the same token usage as the zero-shot methods, which is much smaller than the token count used by ICL. In Large Language Models, the length of input is highly related to the cost when inferring. Our method exhibits some fluctuations, but in the vast majority of cases, it can outperform the performance of zero-shot. Furthermore, in the best-case scenario, it can surpass ICL while using fewer tokens.

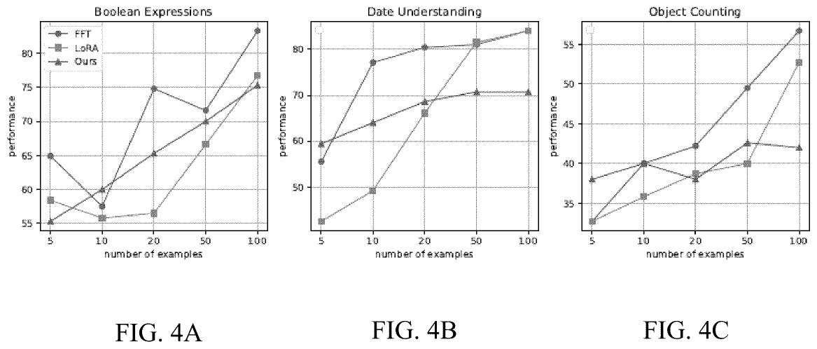

FIGS. 4A-4C show exemplary results of various NLPs according to various embodiments.

The performance of different methods on the aforementioned task under varying sample sizes are shown in FIGS. 4A-4C. The x-axis represents the number of samples, while the y-axis denotes the task performance, measured specifically using the exact match metric.

LoRAHub demonstrates strong few-shot learning capability. ICL and the method disclosed herein are both gradient-free approaches, which means they do not rely on gradient information for optimization. When comparing the method disclosed herein to other gradient based methods like those based on backpropagation, the effectiveness can vary depending on the specific task and dataset.

An analysis by selecting one binary classification task, one multiple-choice question, and one generation task from the BBH dataset. In the case of extremely small sample sizes, all three methods exhibit instability, as evidenced by a decrease in performance with an increase in the number of samples. In this scenario, the method disclosed herein demonstrates comparable or even superior performance compared to methods that utilize backpropagation.

When given larger sample sizes, only in relatively easier tasks such as binary classification, method disclosed herein exhibits performance that is comparable to gradient-based training methods. Although the method disclosed herein demonstrates significant improvements in multi-class classification and generation tasks, there is still a noticeable gap compared to conventional methods.

TABLE 2

| Rank | Task Name | avg. \|wᵢ\| | Task Description |
|---|---|---|---|
| 1 | wiqa_last_process | 0.719 | Identifying the last step of a given process. |
| 2 | race_middle_Is_this_the_right_answer | 0.681 | Determining if given answer is correct. |
| 3 | wiqa_final_process | 0.626 | Identifying the final step of a given process. |
| 4 | adversarial_qa_dbidaf_based_on | 0.611 | Answering question created |
| | | | by an adversarial model-in-the-loop. |
| 5 | web_questions_whats_the_answer | 0.583 | Answering question based on |
| | | | information extracted from the web. |

Table 2 presents the top five LoRAs that have been identified as highly useful. These five tasks predominantly involve reading comprehension and reasoning, which are recognized as more demanding skills. Given that the majority of the selected tasks fall under the category of logical reasoning, it is highly justified to regard these tasks, which are closely tied to reasoning abilities, as the most crucial ones. This also serves as evidence that our method effectively reorganizes the abilities within the candidates to better address the downstream tasks.

For optimal LoRA for optimizing the final loss, an experiment was devised. Specifically, the LoRA associated with the downstream task was incorporated into the pool of LoRA candidates, and subsequently assessed whether the resultant outcomes were able to approximate or surpass the effectiveness demonstrated by individual LoRA instances.

A LoRA trained on a task, wikitablequestion (WTQ), was introduced into the existed LoRA candidates. These candidates were originally trained on tasks included in the FLAN training set. Then the WTQ is defined as the downsteam tasks and find the LoRA weights of these LoRA candidates.

In the final set of weights for all LoRA models, the LoRA model trained with the WTQ task exhibits the highest absolute weight value. Furthermore, the performance of the combined LoRA model slightly surpasses the individual performance of the WTQ LoRA model itself.

This successful integration substantiates the efficacy of our search method in identifying the optimal upstream LoRA model for downstream tasks. Moreover, it serves as empirical evidence of the promising results achieved through our approach.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of training a large language model (LLM) for an unseen task T′ comprising:
obtaining a plurality of pre-trained Low-Rank Adaptation (LoRA) modules;
using a set of examples Q to obtain a set of weights for the plurality of pre-trained LoRA modules;
using the set of weights on the plurality of pre-trained LoRA modules to obtain a fused LoRA module; and
applying the fused LoRA module to the LLM to get an adapted LLM for the unseen task T′.

2. The method of claim 1, wherein the adapted LLM is obtained by freezing original weights of the LLM and introducing low-rank matrices from the fused LoRA module that modifies a subset of the original weights of the LLM.

3. The method of claim 1, wherein the plurality of pre-trained LoRA modules are trained using a plurality of upstream tasks T.

4. The method of claim 3, wherein the plurality of upstream tasks T are N different types of upstream tasks for cross-task generalization.

5. The method of claim 1, wherein the plurality of pre-trained LoRA modules used to obtain the fused LoRA module have a same rank.

6. The method of claim 1, wherein the set of weights is obtained through a gradient free algorithm.

7. The method of claim 6, wherein the set of weights obtained through the gradient free algorithm minimizes cross entropy loss on the set of examples Q.

8. The method of claim 1, wherein the set of examples Q is related to the unseen task T′.

9. The method of claim 8, wherein Q is 5.

10. A computer device for training a large language model (LLM) for an unseen task T′ comprising:
a processor, a memory, the memory storing at least one program code, the at least one program code loaded and executed by the processor to:
obtain a plurality of pre-trained Low-Rank Adaptation (LoRA) modules;
use a set of examples Q to obtain a set of weights for the plurality of pre-trained LoRA modules;
use the set of weights on the plurality of pre-trained LoRA modules to obtain a fused LoRA module; and
apply the fused LoRA module to the LLM to get an adapted LLM for the unseen task T′.

11. The computer device of claim 10, wherein the adapted LLM is obtained by freezing original weights of the LLM and introducing low-rank matrices from the fused LoRA module that modifies a subset of the original weights of the LLM.

12. The computer device of claim 10, wherein the plurality of pre-trained LoRA modules are trained using a plurality of upstream tasks T.

13. The computer device of claim 12, wherein the plurality of upstream tasks T are N different types of upstream tasks for cross-task generalization.

14. The computer device of claim 10, wherein the plurality of pre-trained LoRA modules used to obtain the fused LoRA module have a same rank.

15. The computer device of claim 10, wherein the set of weights is obtained through a gradient free algorithm.

16. The computer device of claim 15, wherein the set of weights obtained through the gradient free algorithm minimizes cross entropy loss on the set of examples Q.

17. The computer device of claim 10, wherein the set of examples Q is related to the unseen task T′.

18. The computer device of claim 17, wherein Q is 5.

19. A computer readable storage medium, characterized in that the storage medium stores at least one program code for execution by a processor to implement operations for:
obtaining a plurality of pre-trained Low-Rank Adaptation (LoRA) modules;
using a set of examples Q to obtain a set of weights for the plurality of pre-trained LoRA modules;
using the set of weights on the plurality of pre-trained LoRA modules to obtain a fused LoRA module; and
applying the fused LoRA module to a large language model (LLM) to get an adapted LLM for an unseen task T′.

20. The computer readable storage medium of claim 19, wherein the adapted LLM is obtained by freezing original weights of the LLM and introducing low-rank matrices from the fused LoRA module that modifies a subset of the original weights of the LLM.
